(19) United States
(12) Patent Application Publication
(10) Pub. No.: US 2020/0356994 A1
(43) Pub. Date: Nov. 12, 2020

(54) SYSTEMS AND METHODS FOR REDUCING FALSE POSITIVES IN ITEM DETECTION

(71) Applicant: PAYPAL, INC., San Jose, CA (US)

(72) Inventors: Ramnarayan Vijapur Gopinath Rao, Chennai (IN); Rajkumar Baskaran, Velapadi (IN)

(21) Appl. No.: 16/405,350

(22) Filed: May 7, 2019

(51) Int. Cl. G06Q 20/40; G06K 9/62; H04L 29/08; G06Q 50/00

(52) U.S. Cl. CPC G06Q 20/4016; G06Q 20/4014; G06Q 50/01; H04L 67/306; G06K 9/6215

(57) ABSTRACT

Methods and systems are presented for reducing false positives in detecting profiles that are connected to an entity within a list of entities. A set of profiles may be matched with the entity based on information associated with the entity. The information associated with the entity may be enriched based on common attributes that are shared among the entities within the list. A machine learning model may be used to determine a likelihood that a matched profile is connected to the entity based on the enriched information. Profiles having corresponding likelihoods below a predetermined threshold may be removed from the set of matched profiles. The matched profiles may be clustered around the entity based on a set of attributes derived from the enriched information, and profiles that fall outside of the cluster may be further removed.

### BACKGROUND

The present specification generally relates to process automation based on machine learning, and more specifically, to reducing false positives in item detection using the process automation according to various embodiments of the disclosure.

### RELATED ART

Conducting electronic transactions (e.g., purchasing products, fund transfer, etc.) over the Internet offers tremendous benefits. However, due to its anonymous nature, the Internet also provides opportunities for malicious users to conduct fraudulent transactions without being noticed. For example, malicious users may use different accounts (e.g., frequently creating new accounts) to conduct the fraudulent transactions, making it challenging to detect. In order to prevent losses, service providers that provide online services to users may wish to detect and/or identify profiles (e.g., user accounts) that are connected to the malicious users who have previously conducted fraudulent transactions so that the service providers may perform preventive actions (e.g., locking the user accounts, increasing security requirement for the user accounts, etc.) before fraudulent transactions are conducted using the user accounts. Since information associated with the malicious users may be limited (e.g., only a first name and a last name of a malicious user is available, etc.), using the limited information of the malicious users to detect profiles that are connected to the malicious users may result in a large number of false positives (e.g., over 90% of the matched profiles are false positives). Thus, there is a need for reducing false positives in detecting malicious profiles based on limited information.

### BRIEF DESCRIPTION OF THE FIGURES

FIG. 1 is a block diagram illustrating an electronic transaction system according to an embodiment of the present disclosure;

FIG. 2 is a block diagram illustrating a profile matching module according to an embodiment of the present disclosure;

FIG. 3 is a flowchart showing a process of reducing false positives in detecting profiles that are connected to an entity according to an embodiment of the present disclosure;

FIG. 4 illustrates a cluster formed around the particular entity according to an embodiment of the present disclosure;

FIG. 5 illustrates another exemplary artificial neural network according to an embodiment of the present disclosure; and

FIG. 6 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes methods and systems for using machine learning based intelligent process automation to reduce false positives in detecting profiles that are connected to a particular entity. As discussed above, service providers that offer a platform for conducting electronic transactions may, as a measure to protect its platform and its legitimate users, detect profiles that are associated with one or more entities (e.g., malicious users) based on limited information. In one embodiment, limited information may be defined as information that does not include all information or data required by a service provider to uniquely identify a profile and/or an account. Each profile may be associated with one or more accounts with the service providers. For example, the service provider may generate a list of malicious users who have previously performed fraudulent transactions. Accounts that were associated with the malicious users may be locked or removed by the service provider, but the malicious users may create new accounts with the service provider (or other service providers) and conduct fraudulent transactions again using the new accounts. In another example, various service providers may share information regarding malicious users, such that a service provider may receive information related to a list of malicious users who have previously conducted fraudulent transactions with one or more other service providers. Since the malicious users may not provide accurate information (or may provide transient information) when creating accounts with the service providers, the information related to the malicious users (whether generated by the service providers or provided by other organizations) may be limited (e.g., may fail to satisfy a set of criteria, etc.). For example, the information associated with each malicious user may include only a first name and a last name. As such, an attempt to detect one or more profiles that are connected to the malicious user based on the limited information may produce a number of profiles, where a large portion of which may not be connected to the malicious user (e.g., false positives). Producing such a large number of matching profiles (the majority of which are false positives) may render the effort of protecting the platform and the legitimate users ineffective, as security measure may be imposed on many legitimate user accounts that are not connected to the malicious user but was matched based on the limited information, or additional resources will be required to filter out the false positives.

To address the above, according to various embodiments of the disclosure, a profile matching system may adopt an intelligent process automation approach to reduce false positives in the matched profiles. Under the intelligent process automation approach, the profile matching system may perform one or more automated processes to remove at least one profile from a set of matched profiles that are matched with a malicious user based on information associated with the malicious user, to reduce the number of false positives below a predetermined threshold. Information associated with a list of malicious users may be provided to the profile matching system. For example, a service provider may generate the information based on user accounts associated with previously detected fraudulent transactions. The information may also be provided by other service providers or organizations. As discussed herein, the information associated with the list of malicious users may be limited, such that using only the information to detect profiles connected to the malicious users in the list may result in a large number of false positives.

In some embodiments, when the profile matching system receives the information, the profile matching system may determine whether the information received satisfies a set of criteria. For example, since each malicious user is connected to one (or at most a few) profiles with a service provider, the profile matching system may identify a set of profiles that match a first malicious user in the list of malicious users based on the information, and determine that the information satisfies the set of criteria when the set of profiles has less than a predetermined number of profiles (e.g., 2, 5, 10, 20, etc.).

The set of profiles exceeding the predetermined number of profiles may indicate that the set of profiles includes a number of false positives (e.g., profiles that are matched based on the information provided but are not connected to the malicious user). Thus, when it is determined that the information received fails the set of criteria, the profile matching system may perform one or more automated processes to reduce the number of false positives within the set of profiles. In some embodiments, the profile matching system may enrich the information associated with the malicious user and use the enriched information to determine one or more profiles within the set that are no longer matches with the malicious user. For example, since the malicious user is provided to the profile matching system within a list of malicious users, the profile matching system may derive additional information based on the list and/or attributes of other malicious users within the list. In a non-limiting example, the list may be generated (either by the service provider or by another organization) based on a set of characteristics (e.g., users who have performed a particular type of scam, users who have committed a particular type of misconduct, etc.). Thus, the profile matching system may derive the common attribute(s) (e.g., the particular type of scam, the particular type of misconduct, etc.) and add the common attribute(s) to the information associated with the malicious users. In another example, while some of the information associated with the malicious user is transient or arbitrarily made up by the malicious users (e.g., a physical address, etc.), the profile matching system may determine common attributes based on the transient information (e.g., all malicious users in the list are from a particular region, such as California, Czech Republic, etc.). The profile matching system may then add the common attribute (e.g., the common region from the malicious users) to the information associated with the malicious user.

The profile matching system may then use the enriched information associated with the malicious user to remove, from the set of profiles, one or more profiles based on the enriched information. For example, the profile matching system may remove profiles from the set that are not associated with the additional attributes determined for the malicious user. However, the profile matching system may not be able to determine whether a profile is associated with at least some of the additional attributes based on the data within the profile. For example, the data within the profile may not have information about whether the profile is associated with a particular type of scam or whether the profile is associated with a particular type of misconduct, etc. As such, the profile matching system of some embodiments, may also enrich the data included in the profile by obtaining information either internally within a service provider system or externally (e.g., from a social media site, from a news site, etc.). For example, since a particular pattern of transactions may indicate the particular type of scam and/or the particular type of misconduct, the profile matching system may obtain past transactions associated with the profile (or account(s) associated with the profile) and determine whether the past transactions exhibit behavior (e.g., exhibit a pattern, etc.) consistent with the particular type of scam and/or the particular type of misconduct (e.g., whether the particular pattern can be detected within past transactions).

In some embodiments, the profile matching system may use a machine learning model to determine a likelihood that each profile is connected to the malicious user based on the enriched information associated with the malicious user and the enriched data within the profile. The machine learning model may be configured to receive the enriched information associated with the malicious user and the enriched data of a profile as input variables, and to output a value corresponding to a likelihood that the profile is connected to the malicious user. The profile matching system may then remove profiles having corresponding likelihoods of being connected to the malicious user below a predetermined threshold (e.g., 40%, 30%, etc.).

Instead of or in addition to using the machine learning model, the profile matching system may use one or more clustering algorithms to further reduce false positives from the set of profiles. In some embodiments, the profile matching system may determine a position within a multi-dimensional space for the malicious user and for each of the profile in the set of profiles based on a set of attributes. The set of attributes may include attributes associated with the enriched information (e.g., first name, last name, a gender, a citizenship, a particular type of scam, a particular type of misconduct, a particular geographical region, etc.). The profile matching system may then determine a cluster surrounding the malicious user (e.g., the malicious user being the center of the cluster) based on one or more parameters. The one or more parameters may be used to determine a size (e.g., a radius) and/or a shape of the cluster. The profile matching system may identify profiles that are outside of the cluster (e.g., the profiles that are farther away from the malicious user based on the set of attributes) and remove the identified profiles from the set of profiles.

In some embodiments, the profile matching system may iteratively perform the clustering and removing of profiles until the number of profiles in the set of profiles is less than a predetermined threshold. The profile matching system may adjust the one or more parameters that control the size and/or the shape of the cluster at each iteration such that the size of the cluster is smaller at each iteration. The profile matching system may continue to remove profiles from the set of profiles that are outside of the cluster at each iteration until the number of profiles in the set is less than the predetermined threshold.

After performing the one or more automated processes (that may include the enrichment of information, machine learning, and clustering), the set of profiles have been reduced to satisfy a criterion (e.g., below the predetermined number of profiles). The service provider may then perform actions for the set of profiles to prevent future losses. For example, the service provider may automatically lock the accounts associated with the set of profiles or increase security measures (e.g., increase the authentication requirement) for the accounts associated with the set of profiles.

While the profile matching system is illustrated herein using the example of detecting malicious users of an online service provider, the profile matching system can be applied to other use cases associated with unwanted actions or behavior without departing from the spirit of the disclosure. For example, the profile matching system can be used to detect fraudulent insurance claims. The list of entities (e.g., the blacklist) may include names of physicians who were used in prior fraudulent claims. The profile matching system can enrich the information related to the physicians by obtaining types of disease, drugs prescribed, and treatment cost associated with other physicians who are involved in similar fraudulent insurance scams. The information regarding the physician may be clustered with insurance claims to detect whether any of the insurance claims are connected to fraudulent insurance scams.

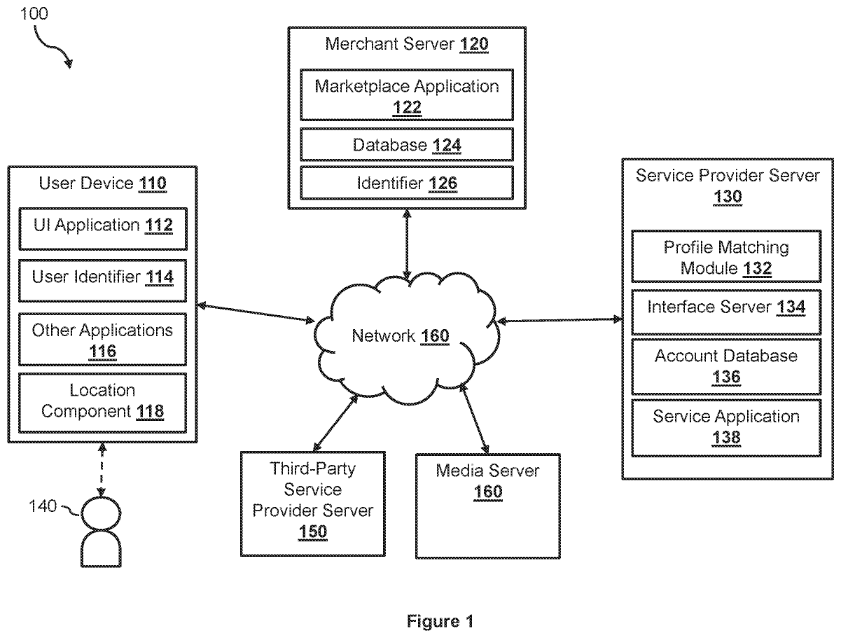

FIG. 1 illustrates an electronic transaction system 100, within which the profile matching system may be implemented according to one embodiment of the disclosure. The electronic transaction system 100 includes a service provider server 130, a merchant server 120, a third-party service provider server 150, a media server 160, and a user device 110 that may be communicatively coupled with each other via a network 160. The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet.

The user device 110, in one embodiment, may be utilized by a user 140 to interact with the merchant server 120 and/or the service provider server 130 over the network 160. For example, the user 140 may use the user device 110 to conduct an online purchase transaction with the merchant server 120 via a website hosted by the merchant server 120, a mobile application associated with the merchant server 120, or a point-of-sale (POS) system associated with the merchant server 120. The user 140 may also log in to a user account to access account services or conduct electronic transactions (e.g., account transfers or payments) with the service provider server 130. The user device 110, in various embodiments, may be implemented using any appropriate combination of hardware and/or software configured for wired and/or wireless communication over the network 160. In various implementations, the user device 110 may include at least one of a wireless cellular phone, wearable computing device, PC, laptop, etc.

The user device 110, in one embodiment, includes a user interface application 112 (e.g., a web browser, a mobile payment application, etc.), which may be utilized by the user 140 to conduct electronic transactions (e.g., online payment transactions, etc.) with the merchant server 120 and/or the service provider server 130 over the network 160. In one aspect, purchase expenses may be directly and/or automatically debited from an account related to the user 140 via the user interface application 112.

In one implementation, the user interface application 112 includes a software program (e.g., a mobile application) that provides a graphical user interface (GUI) for the user 140 to interface and communicate with the service provider server 130 and/or the merchant server 120 via the network 160. In another implementation, the user interface application 112 includes a browser module that provides a network interface to browse information available over the network 160. For example, the user interface application 112 may be implemented, in part, as a web browser to view information available over the network 160.

The user device 110, in various embodiments, may include other applications 116 as may be desired in one or more embodiments of the present disclosure to provide additional features available to the user 140. In one example, such other applications 116 may include security applications for implementing client-side security features, programmatic client applications for interfacing with appropriate application programming interfaces (APIs) over the network 160, and/or various other types of generally known programs and/or software applications. In still other examples, the other applications 116 may interface with the user interface application 112 for improved efficiency and convenience.

The user device 110, in one embodiment, may include at least one identifier 114, which may be implemented, for example, as operating system registry entries, cookies associated with the user interface application 112, identifiers associated with hardware of the user device 110 (e.g., a media control access (MAC) address), or various other appropriate identifiers. In various implementations, the identifier 114 may be passed with a user login request to the service provider server 130 via the network 160, and the identifier 114 may be used by the service provider server 130 to associate the user with a particular user account (e.g., and a particular profile) maintained by the service provider server 130.

In various implementations, the user 140 is able to input data and information into an input component (e.g., a keyboard) of the user device 110 to provide user information with a transaction request, such as a login request, a fund transfer request, a request for adding an additional funding source (e.g., a new credit card), or other types of request. The user information may include user identification information.

The user device 110, in various embodiments, includes a location component 118 configured to determine, track, monitor, and/or provide an instant geographical location of the user device 110. In one example, the location information may be directly entered into the user device 110 by the user via a user input component, such as a keyboard, touch display, and/or voice recognition microphone. In another example, the location information may be automatically obtained and/or provided by the user device 110 via an internal or external monitoring component that utilizes a global positioning system (GPS), which uses satellite-based positioning, and/or assisted GPS (A-GPS), which uses cell tower information to improve reliability and accuracy of GPS-based positioning. For example, location information may be obtained by checking in using the user device 110 via a check-in device at a location or in an authentication process to determine if a request coming from the user device 110 is fraudulent or valid.

Even though only one user device 110 is shown in FIG. 1, it has been contemplated that one or more user devices (each similar to user device 110) may be communicatively coupled with the service provider server 130 via the network 160 within the system 100.

The merchant server 120, in various embodiments, may be maintained by a business entity (or in some cases, by a partner of a business entity that processes transactions on behalf of business entity). Examples of business entities include merchant sites, resource information sites, utility sites, real estate management sites, social networking sites, etc., which offer various items for purchase and process payments for the purchases. The merchant server 120 may include a merchant database 124 for identifying available items, which may be made available to the user device 110 for viewing and purchase by the user.

The merchant server 120, in one embodiment, may include a marketplace application 122, which may be configured to provide information over the network 160 to the user interface application 112 of the user device 110. For example, the user 140 of the user device 110 may interact with the marketplace application 122 through the user interface application 112 over the network 160 to search and view various items available for purchase in the merchant database 124. The merchant server 120, in one embodiment, may include at least one merchant identifier 126, which may be included as part of the one or more items made available for purchase so that, e.g., particular items are associated with the particular merchants. In one implementation, the merchant identifier 126 may include one or more attributes and/or parameters related to the merchant, such as business and banking information. The merchant identifier 126 may include attributes related to the merchant server 120, such as identification information (e.g., a serial number, a location address, GPS coordinates, a network identification number, etc.).

A merchant may also use the merchant server 120 to communicate with the service provider server 130 over the network 160. For example, the merchant may use the merchant server 120 to communicate with the service provider server 130 in the course of various services offered by the service provider to a merchant, such as payment intermediary between customers of the merchant and the merchant itself For example, the merchant server 120 may use an application programming interface (API) that allows it to offer sale of goods or services in which customers are allowed to make payment through the service provider server 130, while the user 140 may have an account with the service provider server 130 that allows the user 140 to use the service provider server 130 for making payments to merchants that allow use of authentication, authorization, and payment services of the service provider as a payment intermediary. In some embodiments, the merchant server 120, through interactions with various users, such as the user140 via the user device 110, may determine malicious users who have performed fraudulent transactions with the merchant server 120. The merchant server 120 may then send information associated with the malicious users to the service provider server 130. The merchant may also have an account with the service provider server 130. Even though only one merchant server 120 is shown in FIG. 1, it has been contemplated that one or more merchant servers (each similar to merchant server 120) may be communicatively coupled with the service provider server 130 and the user device 110 via the network 160 in the system 100.

The service provider server 130, in one embodiment, may be maintained by a transaction processing entity or an online service provider, which may provide processing for electronic transactions between the user 140 of user device 110 and one or more merchants. As such, the service provider server 130 may include a service application 138, which may be adapted to interact with the user device 110 and/or the merchant server 120 over the network 160 to facilitate the searching, selection, purchase, payment of items, and/or other services offered by the service provider server 130. In one example, the service provider server 130 may be provided by PayPal®, Inc., of San Jose, Calif., USA, and/or one or more service entities or a respective intermediary that may provide multiple point of sale devices at various locations to facilitate transaction routings between merchants and, for example, service entities.

In some embodiments, the service application 138 may include a payment processing application (not shown) for processing purchases and/or payments for electronic transactions between a user and a merchant or between any two entities. In one implementation, the payment processing application assists with resolving electronic transactions through validation, delivery, and settlement. As such, the payment processing application settles indebtedness between a user and a merchant, wherein accounts may be directly and/or automatically debited and/or credited of monetary funds in a manner as accepted by the banking industry.

The service provider server 130 may also include an interface server 134 that is configured to serve content (e.g., web content) to users and interact with users. For example, the interface server 134 may include a web server configured to serve web content in response to HTTP requests. In another example, the interface server 134 may include an application server configured to interact with a corresponding application (e.g., a service provider mobile application) installed on the user device 110 via one or more protocols (e.g., RESTAPI, SOAP, etc.). As such, the data server 134 may include pre-generated electronic content ready to be served to users. For example, the data server 134 may store a log-in page and is configured to serve the log-in page to users for logging into user accounts of the users to access various service provided by the service provider server 130. The data server 134 may also include other electronic pages associated with the different services (e.g., electronic transaction services, etc.) offered by the service provider server 130. As a result, a user may access a user account associated with the user and access various services offered by the service provider server 130, by generating HTTP requests directed at the service provider server 130.

In various embodiments, the service provider server 130 includes a profile matching module 132 that implements the profile matching system as discussed herein. The profile matching module 132 is configured to match one or more profiles (e.g., associated user accounts of the service provider server 130) with an entity (e.g., a malicious user) based on information associated with the entity. The profile matching module may initially determine a set of profiles that match the entity based on information provided by the service provider server 130. However, the number of matched profiles in the set may be above a predetermined threshold, indicating that one or more of the matched profiles are false positives. Thus, in some embodiments, the profile matching module 132 may be configured to enrich the information of the entity and use one or more automated processes to reduce the number of false positives in the set of profiles based on the enriched information.

The service provider server 130, in one embodiment, may be configured to maintain one or more user accounts and merchant accounts in an account database 136, each of which may be associated with a profile and may include account information associated with one or more individual users (e.g., the user 140 associated with user device 110) and merchants. For example, account information may include private financial information of users and merchants, such as one or more account numbers, passwords, credit card information, banking information, digital wallets used, or other types of financial information, transaction history, Internet Protocol (IP) addresses, device information associated with the user account, which may be used by the profile matching module 132 to match profiles to the entity. In certain embodiments, account information also includes user purchase profile information such as account funding options and payment options associated with the user, payment information, receipts, and other information collected in response to completed funding and/or payment transactions.

User profile information may be compiled or determined in any suitable way. In some instances, some information is solicited when a user first registers with a service provider. The information might include demographic information, a survey of purchase interests, and/or a survey of past purchases. In other instances, information may be obtained from other databases. In certain instances, information about the user and products purchased are collected as the user shops and purchases various items, which can also be used to determine whether a request is valid or fraudulent.

In one implementation, a user may have identity attributes stored with the service provider server 130, and the user may have credentials to authenticate or verify identity with the service provider server 130. User attributes may include personal information, banking information and/or funding sources. In various aspects, the user attributes may be passed to the service provider server 130 as part of a login, search, selection, purchase, and/or payment request, and the user attributes may be utilized by the service provider server 130 to associate the user with one or more particular user accounts maintained by the service provider server 130 and used to determine the authenticity of a request from a user device.

The third-party service provider server 150, in various embodiments, may be similar to the service provider server 130, but may be maintained by a third-party service provider. The third-party service provider server 150 may provide various services to users (such as the user 140) via the user device 110 and/or to merchant via the merchant server 120. During the course of providing services to the user 140, the third-party service provider server 150 may detect abnormal activities (e.g., fraudulent transactions) associated with one or more users. The third-party service provider server 150 may generate information associated with a list of malicious users associated with the abnormal activities conducted with the third-party service provider server 150, and may transmit the information associated with the list of malicious users to the service provider server 130. In some embodiments, the profile matching module 132 may obtain information associated with one or more lists of malicious users from the third-party service provider server 150. Even though only one third-party service provider server 150 is shown in FIG. 1, it has been contemplated that one or more third-party service provider servers (each similar to the third-party service provider server 150) associated with different service providers may be communicatively coupled with the service provider server 130 and the user device 110 via the network 160 in the system 100.

The media server 160, in various embodiments, may be configured to provide information to other entities such as the service provider server 130. In some embodiments, the media server 160 may host a social media platform that enables users (e.g., such as the user 140) to contribute data (e.g., posts, multi-media content such as images, etc.) on the social medial platform via the UI application 112. In other embodiments, the media server 160 may be associated with a media outlet (e.g., a news agency), and may include a data server (e.g., a web server) configured to serve news content to users. In some embodiments, the profile matching module 132 may obtain data from the medial server 160 to enrich the information associated with the malicious users and the data included in the profiles maintained by the service provider server 130. Even though only one media server 160 is shown in FIG. 1, it has been contemplated that one or more media servers (each similar to the media server 160) associated with different social medial network and/or news agency may be communicatively coupled with the service provider server 130 and the user device 110 via the network 160 in the system 100.

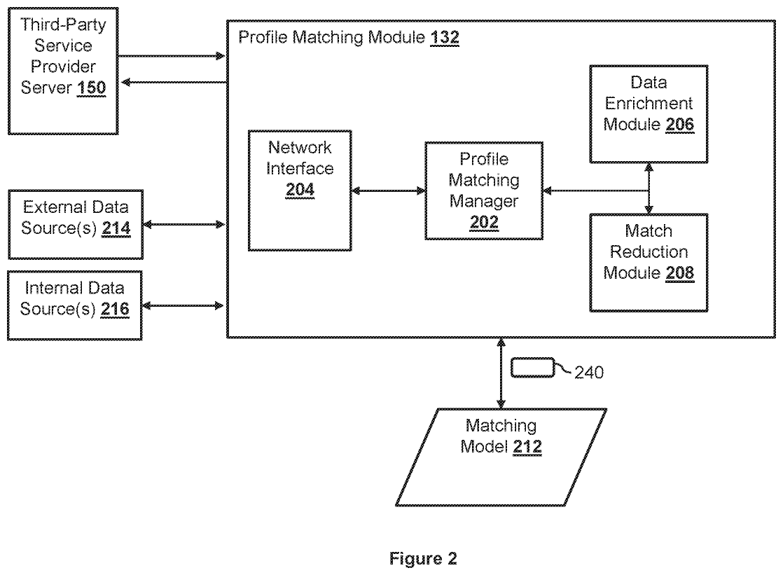

FIG. 2 illustrates a block diagram of the profile matching module 132 according to an embodiment of the disclosure. The profile matching module 132 includes a profile matching manager 202, a network interface 204 that communicatively couples the profile matching module 132 with the third-party service provider server 150, one or more external data sources 214 (e.g., the media server 160), and one or more internal data sources 216 (e.g., the account database 136). The profile matching manager 202 may receive information associated with one or more malicious users (e.g., a list of malicious users) from the third-party service provider server 150 (which may also be the merchant server 120). The profile matching manager 202 may match a set of profiles from profiles stored in the account database 136 with a malicious user from the list based on the information. However, the number of matched profiles based on the information may be above a predetermined threshold, indicating that one or more matched profiles (e.g., sometimes as high as over 90% of the matched profiles) are false positives (e.g., matched profiles that are not connected to the malicious user). As such, the profile matching manager 202 may use the data enrichment module 206 to enrich the information associated with the malicious user.

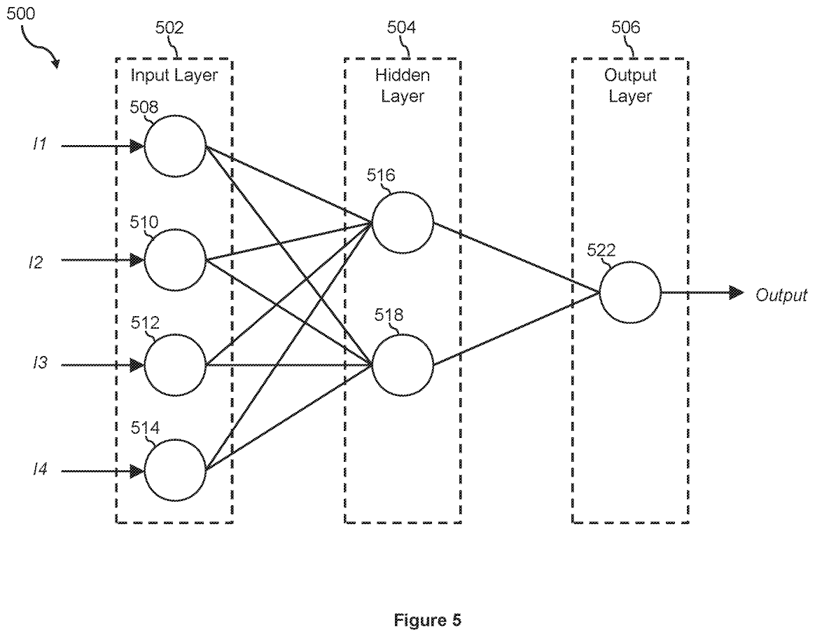

In some embodiments, the data enrichment module 206 may enrich the information associated with the malicious user by deriving one or more additional attributes that are shared among the malicious users in the list of malicious users. The data enrichment module 206 may also obtain additional data from the external data source(s) 214 and/or the internal data source(s) 216 to enrich the data of the matched profiles. The profile matching manager 202 may then use the match reduction module 208 to remove one or more matched profiles from the set of matched profiles using the enriched information associated with the malicious user and the enriched data in the profiles. In some embodiments, the match reduction module 208 may use a machine learning model (e.g., the matching model 212) to determine a likelihood that a profile is connected to the malicious user based on the enriched information associated with the malicious user and the enriched data in the profile. For example, the matching model 212 may be configured (and trained from historic data) to receive enriched data of a profiles and the enriched information of the entity as input values and produce an output that indicates a likelihood that the profile matches the entity (e.g., a percentage). An exemplary implementation of the matching model 212 is described in more detail below by reference to FIG. 5. The match reduction module 208 may remove profiles from the set of matched profiles with a corresponding likelihood below a predetermined threshold (e.g., 40%, 30%, etc.). The match reduction module 208 may also use one or more clustering algorithms to form a cluster around the malicious user based on a set of attributes derived from the enriched information, and remove profiles that are positioned outside of the cluster. The reduced set of profiles may then be used to improve the security of the service provider server 130. For example, the service provider server 130 may lock the user accounts associated with the reduced set of profiles, or may increase the security requirements (e.g., authentication requirements) for the user accounts associated with the reduced set of profiles.

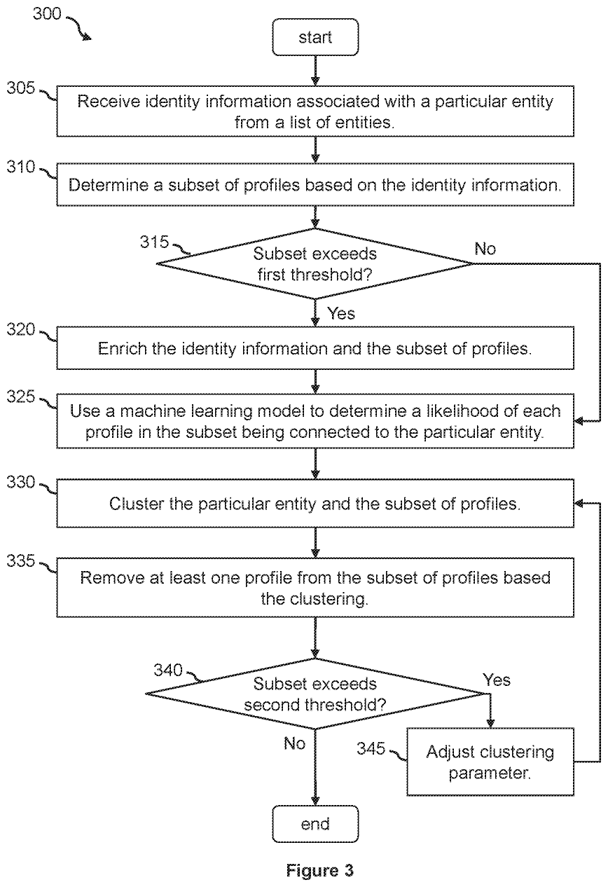

FIG. 3 illustrates a process 300 for reducing false positives in detecting profiles that are connected to an entity. In some embodiments, the process 300 may be performed by the profile matching module 132 of the service provider server 130. The process 300 begins by receiving or accessing (at step 305) identity information associated with a particular entity from a list of entities. For example, the profile matching module 132 may receive or access information (e.g., identity information) associated with a list of entities (e.g., a list of malicious users) from one or more sources. In some embodiments, the service provider server 130 may monitor user interactions of users (e.g., the user 140) with the service provider server 130 and may detect any abnormal activities (e.g., fraudulent transactions such as scamming other users, failure to fulfill an obligation such as shipping a product, etc.) from the users. For example, the service provider server 130 may detect the abnormal activities when the interactions of the users with the service provider server 130 match one or more patterns that are associated with a particular malicious activity. In some embodiments, in response to detecting the abnormal activities, the service provider server 130 may perform actions to the user accounts (e.g., locking the user accounts, increasing security requirements associated with the user accounts, etc.) associated with such malicious users. However, the malicious users may create new user accounts with the service provider server 130 (or with other service providers such as the third-party service provider server 150) and may continue to perform fraudulent transactions using the new user accounts. Thus, the service provider server 130 may compile information associated with a list of malicious users who have performed fraudulent transactions in the past with the service provider server 130, and request the profile matching module 132 to match profiles stored in the account database 136 that match the list of malicious users, such that the service provider server 130 may perform preventive actions to the user accounts associated with the matched profiles before fraudulent transactions are performed using those user accounts.

In some embodiments, the information associated with the list of entities may be obtained from third-party, such as the merchant server 120 and/or the third-party service provider server 150. For example, the merchant server 120 and/or the third-party service provider server 150, through interactions with various users, may detect abnormal behavior (e.g., fraudulent transactions), from the users. Similar to the service provider server 130, the merchant server 120 and/or the third-party service provider server 150 may detect abnormal behavior by monitoring user interactions of users (e.g., the user 140) with the service provider server 130 and matching the interactions of the users with one or more patterns that are associated with a particular malicious activity. In response to detecting the abnormal behavior, the merchant server 120 and/or the third-party service provider server 150 may compile information associated with a list of entities (e.g., malicious users) that are linked to the abnormal behavior. The merchant server 120 and/or the third-party service provider server 150 may also share the information associated with the list of entities with the service provider server 130.

The process 300 then determines (at step 310) a subset of profiles based on the identification information and determines (at step 315) whether the subset of profiles exceeds a first threshold number of profiles. For example, when the profile matching module 132 receives or accesses the information associated with the list of malicious users, the profile matching module 132 may determine whether the information satisfies one or more criteria. As discussed herein, the information associated with each entity may be limited (e.g., not sufficient to identify only the profile(s) that is connected to the entity). In a particular scenario, the information associated with the list of entities provided by a third-party (e.g., the merchant server 120, the third-party service provider server 150, etc.) may only include limited information such as a first name and a last name. In another scenario, since the malicious user intends to create many accounts and wants to avoid being caught, the malicious user may use transient information during the registration of the user accounts and or while using the services offered by the service provider server 130. For example, the malicious user may use a temporary device (e.g., the user device 110) for conducting a transaction with the service provider server 130, and may use another device for conduction transactions under a different account. Thus, the information associated with the user device 110 (e.g., the Internet Protocol (IP) address of the device or mobile device identifiers (IDs)) may include transient information (e.g., information that cannot be used to match the profile). In another example, the malicious user may use a temporary physical address for the user account, and may use another user address for a different account (e.g., the malicious user may rotate a set of physical addresses shared among a group of malicious users, etc.). Thus, the physical address information of the malicious may also be transient (e.g., information that cannot be used to match the profile). As such, the information that may be used to match the profile(s) with the entity become limited, such that profiles that are not in fact connected to the malicious users may be matched based on the information alone (e.g., false positives).

Since a malicious user is usually connected to a limited number of profiles (e.g., user accounts). When the number of profiles being matched to a particular entity (e.g., a particular malicious user) exceeds a predetermined number (e.g., 10, 50, 100, etc.), it is an indication that a portion of the matched profiles are false positives. Accordingly, in some embodiments, the one or more criteria is related to a number of threshold number of matching profiles (e.g., whether the information is sufficient to identify profiles that are connected to the malicious users). The profile matching module 132 may identify a subset of profiles, from the profiles stored in the account database 136, that match a particular entity from the list of entities based on the information, and may determine if the number of profiles included in the subset of profiles exceeds the predetermined threshold (e.g., 10, 50, 100, etc.).

If it is determined that the subset of profiles exceeds the first threshold number of profiles, the process 300 enriches (at step 320) the identity information associated with the entity and data included in the subset of profiles. For example, the profile matching manager 202 may use the data enrichment module 206 to enrich the information associated with the entity (e.g., the malicious user). In some embodiments, the data enrichment module 206 may enrich the information associated with the entity and use the enriched information to determine one or more profiles within the subset of profiles that are no longer matches with the entity. For example, since the entity is provided to the profile matching module 132 in a list that includes other entities, the data enrichment module 206 may derive additional information based on the list and/or attributes of other entities within the list. In a non-limiting example, the list may be generated (either by the service provider server 130 or by another organization such as the merchant server 120 and/or the third-party service provider server 150) based on a set of characteristics (e.g., users who have performed a particular type of scam, users who have committed a particular type of misconduct, etc.). Thus, the data enrichment module 206 may derive attribute(s) based on the characteristics of the list (e.g., the particular type of scam, the particular type of misconduct, etc.), and add the attribute(s) to the information associated with the entity (e.g., that the entity is associated with the particular type of scam, the particular type of misconduct, etc.). In another example, even though some of the information associated with the entity is transient or arbitrarily made up by the entity (e.g., a physical address, an IP address of the device used by the entity, etc.), the data enrichment module 206 may use the transient information to derive attributes that are common among the entities in the list. In one scenario, when all of the entities in the list have physical addresses within (or IP addresses associated with) a particular region, the data enrichment module 206 may then add the common attribute(s) (e.g., the common region) to the information associated with the entity.

In addition to enriching the information associated with the entity, the data enrichment module 206 of some embodiments may also enrich the data within the subset of profiles. In some embodiments, the data enrichment module 206 may enrich the data within the subset of profiles based on the attributes added to the information associated with the entity. For example, if the data enrichment module 206 added an attribute related to the type of fraudulent transaction (e.g., a particular type of scam) to the information associated with the entity, the data enrichment module 206 may determine a particular pattern of transactions (e.g., performing a number of transactions at a particular amount range within a particular time period) that provide an indication of the particular type of scam. The data enrichment module 206 may then retrieve, for each profile in the subset of profiles, transaction history (e.g., from an internal data source 216 such as the account database 136, and may determine whether the transactions associated with the profile exhibit the particular pattern (e.g., whether the account was used to conduct a number of transactions at the particular amount range within the particular time period). In some embodiments, the data enrichment module 206 may use one or more pattern recognition algorithms (e.g., a regression model, an artificial neural network, etc.) to detect whether the particular pattern can be recognized in the transactions associated with the profile. The data enrichment module 206 may then determine whether the particular attribute is associated with the profile based on whether the particular pattern is recognized/detected in the transactions associated with the profile. The information related to whether the particular attribute is associated with a profile may then be added to (enriched) the data included in the profile to enrich the profile.

The data enrichment module 206 of some embodiments may also enrich the data included in the profiles by obtaining information from one or more external data source(s) 214. For example, when one of the additional attributes derived from the information associated with the entity corresponds to a region (e.g., Czech Republic), the data enrichment module 206 may scrape through social media accounts of the profiles and/or news media (e.g., via the media server 160) to obtain information regarding whether the user associated with the profile has recently visited the region, whether the user (a name of the user) appears on the news, whether the user is associated with a post on a social media site, etc.

After enriching the information associated with the entity and the data included in the subset of profiles, the process 300 may perform one or more automated processes to remove, from the subset of profiles, one or more profiles that are no longer matches with the entity based on the enriched information. In some embodiments, when it is determined that the subset of profiles does not exceed the first threshold at the step 315, the process 300 may skip the enrichment step 320 and directly perform the automated processes to remove the one or more profiles. For example, as part of the automated processes, the process 300 uses (at step 325) a machine learning model to determine a likelihood of each profile in the subset of profiles being connected to the particular entity. In some embodiments, the match reduction module 208 may use a machine learning model (e.g., the matching model 212) to determine a likelihood that a profile within the subset of profile is connected to the entity.

The matching model 212 may be implemented in different manners. In some embodiments, the matching model 212 may be implemented as an artificial neural network, a gradient boosting machine, a logistic regression model, etc. The matching model 212 of some embodiments may be configured to receive a set of input values corresponding to the enriched data of the profile and produce an output 240 that corresponds to a likelihood that the profile is connected to the entity. In some embodiments, the input values for the matching model 212 correspond to the enriched information associated with the entity. For example, when the enriched information associated with the entity includes information such as a first name, a last name, a geographical region, a particular type of scam, the input values for the matching model 212 may correspond to a first name, a last name, a geographical region, a particular type of scam as well. In some embodiments, the matching model 212 may be configured to receive actual data included in the profile that corresponds to the set of attributes (e.g., first name, last name, geographical region, particular type of scam). Alternatively, the matching model 212 may be configured to receive, at least for some input values, a Boolean value (e.g., true/false) indicating whether a particular attribute (e.g., the particular type of scam) is associated with the profile. Using the actual data included in the profile enables the matching model 212 may receive data that is similar but not identical to the entity. For example, the matched profile may include a last name that is similar to the last name of the entity except for one character (e.g., Simone vs. Simon). The matching model 212 may use the degree of similarity to generate the output. However, for some attributes, it may not be practical to include the actual data included in the profile. For example, for the attribute of the particular type of scam, it may not be practical to include all of the transaction history associated with the profile. Instead, the matching model 212 may be configured to receive a Boolean value indicating whether the transaction history exhibits a pattern that is associated with the particular type of scam.

Furthermore, since the number of attributes added to the information associated with the entity may vary (e.g., the data enrichment module 206 may derive different numbers of attributes for different entities), the matching model 212 may be configured to receive a fixed number of input values (e.g., 1, 3, 5, etc.) that represent all of the added attributes. Thus, in some embodiments, the match reduction module 208 may encode information associated with the added attributes (e.g., whether the profile is associated with the added attributes) into a single input value before providing the single input value to the matching model 212. In one example, the match reduction module 208 may encode the Boolean data associated with the added attributes in a series of bits (e.g., an 8-byte value, a 16-byte value, etc.). For example, when there are eight added attributes and the profile is associated with the second, fourth, fifth, sixth, and eight attributes, the match reduction module 208 may encode the information into a value of ‘01011101.’ The encoded value may then be provided to the matching model 212 as a single input value for determining the likelihood 240. The match reduction model may remove, from the subset of matched profiles, one or more profiles having corresponding likelihood fall below a predetermined threshold (e.g., 30%, 40%, 60%, etc.).

In addition to using a machine learning model, the automated processes may also include using one or more clustering algorithms to further remove profiles from the subset of matched profiles. Thus, the process 300 clusters (at step 330) the particular entity and the subset of profiles and (at step 335) removes at least one profile from the subset of profiles based on the clustering. For example, the match reduction module 208 may determine a position within a multi-dimensional space for the entity and for each profile in the subset of matched profiles based on a set of attributes. The set of attributes may include attributes associated with the enriched information (e.g., first name, last name, a gender, a citizenship, a particular type of scam, a particular type of misconduct, a particular geographical region, a monetary amount, etc.). Each attribute in the set of attributes may correspond to a distinct dimension in the multi-dimensional space. In each dimension, the position of a profile may be based on a similarity between the profile and the entity with respect to the corresponding attribute. When the profile and the entity share the same attribute (e.g., both having the same nationality), the position of the profile in that dimension may be identical to the position of the entity. The more similar the profile is with the entity with respect to an attribute, the closer position of the profile in the corresponding dimension may be with the position of the entity. Similarly, the more different the profile is with the entity with respect to an attribute, the farther away the position of the profile in the corresponding dimension may be from the position of the entity.

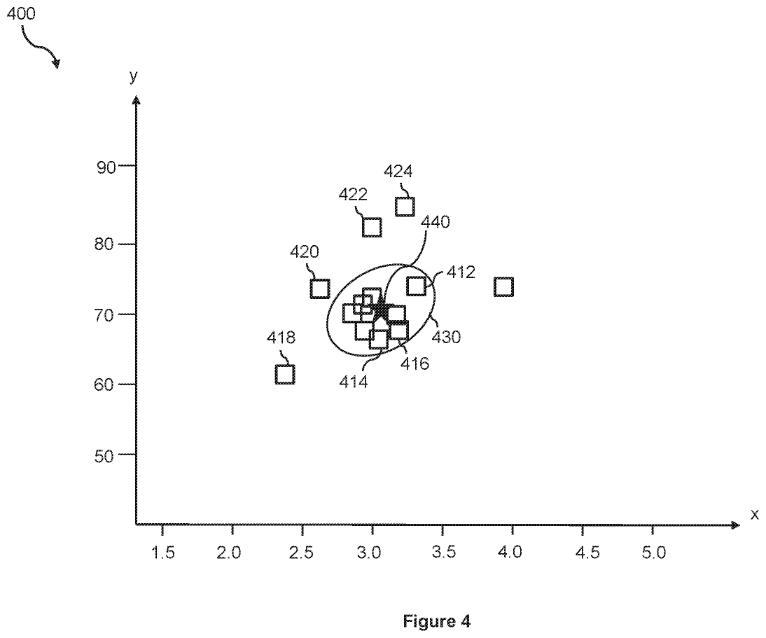

FIG. 4 illustrates positions of the entity and of the matched profiles within a multi-dimensional space 400. In this example, the multi-dimensional space 400 has two-dimension (e.g., dimension x and dimension y) for illustration purpose only. As discussed herein, the multi-dimensional space 400 may have more dimensions depending on the number of attributes associated with the information of the entity. Based on the enriched information associated with the entity, the match reduction module 208 may determine a position 440 for the entity within the multi-dimensional space 400. For example, the match reduction module 208 may encode the information of the entity corresponding to each attribute to a value. A first name, for example, may be encoded by generating a sum of all of the UNICODE values of the letters within the first name.

The match reduction module 208 may then determine a position for each profile in the subset of matched profiles. For example, the match reduction module 208 may determine at least the positions 412-424 for some of the profiles within the subset of matched profiles. As discussed herein, the more similar a profile is with the entity, the closer the position of the profile is with the position of the entity within the multi-dimensional space 400. Thus, since the positions 412, 414, and 416 are closer to the position 440 of the entity than the positions 418, 420, 422, and 424, the profiles corresponding to the positions 412, 414, and 416 are more similar to the entity than the profiles corresponding to the positions 418, 420, 422, and 424. The match reduction module 208 may also generate a cluster 430 based on the position 440 of the entity and one or more parameters. In some embodiments, the generated cluster use the position 440 of the entity as the center. The one or more parameters may determine the size (e.g., a radius) and the shape of the cluster 430.

Once the cluster 430 is generated, the match reduction module 208 may identify profiles having corresponding positions in the multi-dimensional space 400 that are outside of the cluster 430, and may remove the identified profiles from the subset of matched profiles. In this example, since the positions 418, 420, 422, and 424 fall outside of the cluster 430, the match reduction module 208 may remove the profiles corresponding to the positions 418, 420, 422, and 424 from the subset of matched profiles.

In some embodiments, the match reduction module 208 may iteratively perform the clustering and removing of profiles until the number of profiles in the set of profiles is less than a predetermined threshold. The match reduction module 208 may adjust the one or more parameters that control the size and/or the shape of the cluster at each iteration such that the size of the cluster is smaller at each iteration. Thus, the process 300 determines (at step 340) whether the subset of profiles exceeds a second threshold number of profiles. If the subset of profiles still exceeds the second threshold number of profiles, the process 300 adjusts (at step 345) the clustering parameter and reverts back to the step 330 to perform the clustering and removing again. In some embodiments, at each iteration, the match reduction module 208 may adjust the one or more parameters of the cluster such that the cluster is reduced in size (e.g., by a predetermined percentage, etc.). As the size of the cluster is reduced, more profiles will be removed from the subset of matched profiles by the match reduction module 208. The match reduction module 208 may continue to adjust the cluster 430 and remove profiles having positions outside of the cluster 430 until the number of profiles remained in the subset of matched profiles fall below the second threshold (e.g., 2, 5, 10, etc.). By removing profiles that are not as similar to the entity from the subset of profiles, the profile matching module 132 reduces the false positives in the matched profiles.

When the subset of matched profiles has been reduced to satisfy a criterion (e.g., below the second threshold number of profiles), the profile matching module 132 may provide the reduced subset of profiles to another application of the service provider server 130, such that the service provider server 130 may perform actions on the reduced subset of profiles to prevent future losses. For example, the service provider server 130 may automatically lock the accounts associated with the subset of profiles or increase security measures (e.g., increase the authentication requirement) for the accounts associated with the subset of profiles.

FIG. 5 illustrates an example artificial neural network 500 that may be used to implement the matching model 212. As shown, the artificial neural network 500 includes three layers—an input layer 502, a hidden layer 504, and an output layer 506. Each of the layers 502, 504, and 506 may include one or more nodes. For example, the input layer 502 includes nodes 508-514, the hidden layer 504 includes nodes 516-518, and the output layer 506 includes a node 522. In this example, each node in a layer is connected to every node in an adjacent layer. For example, the node 508 in the input layer 502 is connected to both of the nodes 516-518 in the hidden layer 504. Similarly, the node 516 in the hidden layer is connected to all of the nodes 508-514 in the input layer 502 and the node 522 in the output layer 506. Although only one hidden layer is shown for the artificial neural network 500, it has been contemplated that the artificial neural network 500 used to implement the matching module 212 may include as many hidden layers as necessary.

In this example, the artificial neural network 500 receives a set of input values and produces an output value. Each node in the input layer 502 may correspond to a distinct input value. For example, when the artificial neural network 500 is used to implement the matching model 212, each node in the input layer 502 may correspond to a distinct attribute derived from the information associated with an entity (e.g., a first name, a last name, a type of scam, a geographic region, etc.). In a non-limiting example, the node 508 may correspond to a first name, the node 510 may correspond to a last name, the node 512 may correspond to a citizenship, the node 514 may correspond to an encoded value representing a set of additional values derived from the enriched information.

In some embodiments, each of the nodes 516-518 in the hidden layer 504 generates a representation, which may include a mathematical computation (or algorithm) that produces a value based on the input values received from the nodes 508-514. The mathematical computation may include assigning different weights to each of the data values received from the nodes 508-514. The nodes 516 and 518 may include different algorithms and/or different weights assigned to the data variables from the nodes 508-514 such that each of the nodes 516-518 may produce a different value based on the same input values received from the nodes 508-514. In some embodiments, the weights that are initially assigned to the features (or input values) for each of the nodes 516-518 may be randomly generated (e.g., using a computer randomizer). The values generated by the nodes 516 and 518 may be used by the node 522 in the output layer 506 to produce an output value for the artificial neural network 500. When the artificial neural network 500 is used to implement the matching model 212, the output value produced by the artificial neural network 500 may indicate a likelihood that a profile is connected to an entity (e.g., a malicious user).

The artificial neural network 500 may be trained by using training data. By providing training data to the artificial neural network 500, the nodes 516-518 in the hidden layer 504 may be trained (adjusted) such that an optimal output (e.g., a classification) is produced in the output layer 506 based on the training data. By continuously providing different sets of training data, and penalizing the artificial neural network 500 when the output of the artificial neural network 500 is incorrect (e.g., when the determined (predicted) likelihood is inconsistent with whether the profile is connected with the entity, etc.), the artificial neural network 500 (and specifically, the representations of the nodes in the hidden layer 504) may be trained (adjusted) to improve its performance in data classification. Adjusting the artificial neural network 500 may include adjusting the weights associated with each node in the hidden layer 504.

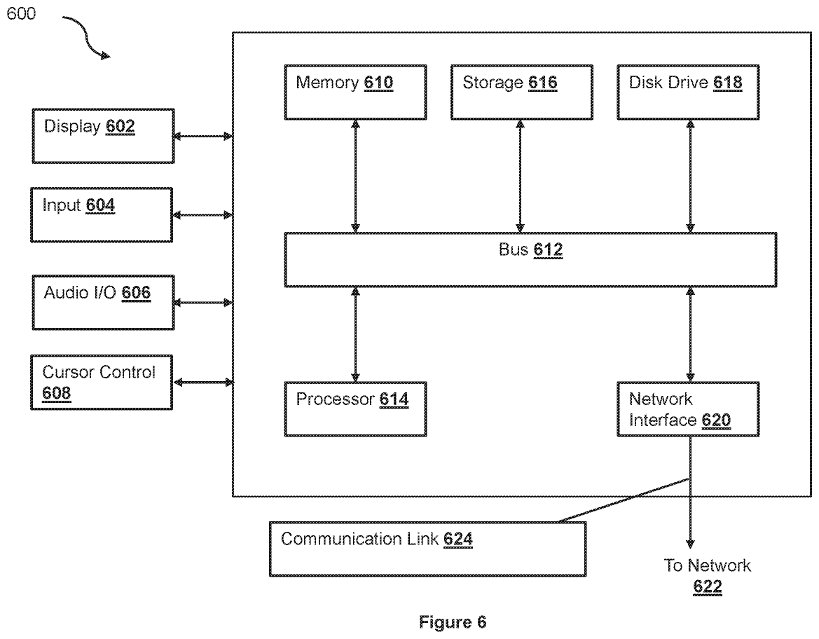

FIG. 6 is a block diagram of a computer system 600 suitable for implementing one or more embodiments of the present disclosure, including the service provider server 130, the merchant server 120, the third-party provider server 150, the media server 160, and the user device 110. In various implementations, the user device 110 may include a mobile cellular phone, personal computer (PC), laptop, wearable computing device, etc. adapted for wireless communication, and each of the service provider server 130, the merchant server 120, the third-party service provider server 150, and the media server 160 may include a network computing device, such as a server. Thus, it should be appreciated that the devices 110, 120, 150, 160, and 130 may be implemented as the computer system 600 in a manner as follows.

The computer system 600 includes a bus 612 or other communication mechanism for communicating information data, signals, and information between various components of the computer system 600. The components include an input/output (I/O) component 604 that processes a user (i.e., sender, recipient, service provider) action, such as selecting keys from a keypad/keyboard, selecting one or more buttons or links, etc., and sends a corresponding signal to the bus 612. The I/O component 604 may also include an output component, such as a display 602 and a cursor control 608 (such as a keyboard, keypad, mouse, etc.). The display 602 may be configured to present a login page for logging into a user account or a checkout page for purchasing an item from a merchant. An optional audio input/output component 606 may also be included to allow a user to use voice for inputting information by converting audio signals. The audio I/O component 606 may allow the user to hear audio. A transceiver or network interface 620 transmits and receives signals between the computer system 600 and other devices, such as another user device, a merchant server, or a service provider server via network 622. In one embodiment, the transmission is wireless, although other transmission mediums and methods may also be suitable. A processor 614, which can be a micro-controller, digital signal processor (DSP), or other processing component, processes these various signals, such as for display on the computer system 600 or transmission to other devices via a communication link 624. The processor 614 may also control transmission of information, such as cookies or IP addresses, to other devices.

The components of the computer system 600 also include a system memory component 610 (e.g., RAM), a static storage component 616 (e.g., ROM), and/or a disk drive 618 (e.g., a solid-state drive, a hard drive). The computer system 600 performs specific operations by the processor 614 and other components by executing one or more sequences of instructions contained in the system memory component 610. For example, the processor 614 can perform the false positives reduction functionalities described herein according to the process 300.

Logic may be encoded in a computer readable medium, which may refer to any medium that participates in providing instructions to the processor 614 for execution. Such a medium may take many forms, including but not limited to, non-volatile media, volatile media, and transmission media. In various implementations, non-volatile media includes optical or magnetic disks, volatile media includes dynamic memory, such as the system memory component 610, and transmission media includes coaxial cables, copper wire, and fiber optics, including wires that comprise the bus 612. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by the computer system 600. In various other embodiments of the present disclosure, a plurality of computer systems 600 coupled by the communication link 624 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system, comprising:
a non-transitory memory; and
one or more hardware processors coupled with the non-transitory memory and configured to read instructions from the non-transitory memory to cause the system to perform operations comprising:
receiving a request for matching a profile, from a plurality of stored profiles, to an entity from a list of entities, wherein the request includes identification information associated with the entity and corresponding to a set of identification attributes;
determining, from the plurality of profiles, a subset of profiles based on the identification information; and
reducing a size of the subset of profiles by:
deriving at least one collective attribute shared among the list of entities;
identifying, from the subset of profiles, at least one profile that does not match the entity based on the set of identification attributes and the at least one collective attribute; and
removing the at least one profile from the subset of profiles to generate a modified subset of profiles.

2. The system of claim 1, wherein the reducing the size of the subset of profiles further comprises determining whether the at least one collective attribute is associated with a first profile in the subset of profiles.

3. The system of claim 1, wherein the reducing the size of the subset of profiles further comprises:
retrieving, from an external server, additional information related to the subset of profiles; and
determining, for each profile in the subset of profiles, whether the at least one collective attribute is associated with the profile based on the additional information.

4. The system of claim 3, wherein the external server is associated with a social media networking site.

5. The system of claim 1, wherein the list of entities is a blacklist generated by a service provider, and wherein the list of entities comprises users of the service provider who have performed fraudulent activities with the service provider.

6. The system of claim 1, wherein the reducing the size of the subset of profiles further comprises:
clustering the modified subset of profiles around the entity based on the set of identification attributes and the at least one collective attribute;
calculating a distance between each profile in the modified subset of profiles with the entity based on the clustering; and
removing, from the modified subset of profiles, one or more profiles having a distance with the entity larger than a predetermined threshold.

7. The system of claim 1, wherein the operations further comprise:
determining that the subset of profiles exceeds a predetermined number of profiles, wherein the size of the subset of profiles is reduced in response to determining that the subset of profiles exceeds the predetermined number of profiles.

8. The system of claim 1, further comprising:
receiving feedback information related to whether any one of the modified subset of profiles is connected to the entity; and
adjusting, based on the feedback information, a machine learning model used for the identifying.

9. A method, comprising:
receiving a request for matching a profile, from a plurality of stored profiles, to an entity from a list of entities, wherein the request includes identification information associated with the entity and corresponding to a set of identification attributes;
determining, from the plurality of profiles, a subset of profiles based on the identification information; and
reducing a size the subset of profiles by:
deriving at least one collective attribute shared among the list of entities;
clustering the subset of profiles around the entity based on the set of identification attributes and the at least one collective attribute;
calculating a distance between each profile in the subset of profiles with the entity based on the clustering; and
removing, from the subset of profiles, at least one profile having a distance with the entity larger than a predetermined threshold distance to generate a modified subset of profiles.

10. The method of claim 9, wherein each profile in the subset of profiles is associated with a user account with a payment service provider, and wherein the reducing the size of the subset of the profiles further comprises:
obtaining a plurality of historical transactions associated with a first profile within the subset of profiles; and
analyzing the plurality of historical transactions to determine whether the at least one collective attribute is associated with the first profile.

11. The method of claim 10, wherein the analyzing comprises determining a frequency of transactions during a predetermined time period.

12. The method of claim 10, wherein the analyzing comprises determining one or more locations associated with the plurality of historical transactions.

13. The method of claim 10, wherein the reducing the size of the subset of profiles further comprises:
using a machine learning model to identify, from the modified subset of profiles, one or more profiles that do not match the entity based on the set of identification attributes and the at least one collective attribute; and
removing the one or more profiles from the modified subset of profiles.

14. The method of claim 9, wherein the reducing the size of the subset of profiles further comprises iteratively performing the clustering, the calculating, and the removing until a number of profiles within the modified subset of profiles is below a predetermined threshold number of profiles, wherein the predetermined threshold distance is adjusted at each iteration.

15. A non-transitory machine-readable medium having stored thereon machine-readable instructions executable to cause a machine to perform operations comprising:
receiving a request for matching a profile, from a plurality of stored profiles, to an entity from a list of entities, wherein the request includes identification information associated with the entity and corresponding to a set of identification attributes;
determining, from the plurality of profiles, a subset of profiles based on the identification information; and
reducing a size of the subset of profiles by:
deriving at least one collective attribute shared among the list of entities;
using a machine learning model to identify, from the subset of profiles, at least one profile that does not match the entity based on the set of identification attributes and the at least one collective attribute; and
removing the at least one profile from the subset of profiles to generate a modified subset of profiles.

16. The non-transitory machine-readable medium of claim 15, wherein the reducing the size of the subset of profiles further comprises:
retrieving, from an external server, additional information related to the subset of profiles; and
determining, for each profile in the subset of profiles, whether the at least one collective attribute is associated with the profile based on the additional information.

17. The non-transitory machine-readable medium of claim 16, wherein the external server is associated with a news media site.

18. The non-transitory machine-readable medium of claim 15, wherein the list of entities is a blacklist generated by a service provider, and wherein the list of entities comprises users of the service provider who have performed fraudulent activities with the service provider.

19. The non-transitory machine-readable medium of claim 15, wherein the reducing the size of the subset of profiles further comprises:
clustering the modified subset of profiles around the entity based on the set of identification attributes and the at least one collective attribute;
calculating a distance between each profile in the modified subset of profiles with the entity based on the clustering; and
removing, from the modified subset of profiles, one or more profiles having a distance with the entity larger than a predetermined threshold.

20. The non-transitory machine-readable medium of claim 1, wherein the operations further comprise:
determining that the subset of profiles exceeds a predetermined number of profiles, wherein the size of the subset of profiles is reduced in response to determining that the subset of profiles exceeds the predetermined number of profiles.
